(19) United States
(12) Patent Application Publication
(10) Pub. No.: US 2026/0155578 A1
(43) Pub. Date: Jun. 4, 2026

(54) FREQUENCY SELECTIVE SURFACE AND COMMUNICATION SYSTEM

(71) Applicant: Nanning FuLian FuGui Precision Industrial Co., Ltd., Nanning (CN)

(72) Inventor: CHIA-SHENG WEI, New Taipei (TW)

(21) Appl. No.: 18/964,840

(22) Filed: Dec. 2, 2024

(51) Int. Cl. H01Q 15/00

(52) U.S. Cl. CPC H01Q 15/0026

(57) ABSTRACT

A frequency selective surface includes a plurality of multi-band array units arranged in a periodic manner, and each multi-band array unit includes a reflection unit and a transmission unit; the reflection unit is arranged on an upper surface of substrate, and the reflection unit includes a first metal rectangular patch, four sides of the first metal rectangular patch are respectively hollowed out an L-shaped slot, so that four sides of the first metal rectangular patch respectively retain a long rectangular branch with one end suspended; the transmission unit is arranged on the upper surface of the substrate, the transmission unit includes a second metal rectangular patch, a center of the second metal rectangular patch is hollowed out a Jerusalem cross slot; the second metal rectangular patch of the transmission unit and the first metal rectangular patch of the reflection unit have a same size and overlap with each other.

### FIELD

The present disclosure generally relates to a technical field of electromagnetic wave, in particular to a frequency selective surface and a communication system.

### BACKGROUND

Frequency Selective Surface (FSS) is a two-dimensional periodic array structure, which can pass electromagnetic lossless or low loss in a specific frequency band, and the electromagnetic wave outside the frequency band is shielded and reflected, which can effectively control the transmission and reflection of electromagnetic waves, similar to a spatial filter. Due to the unique filtering characteristics, FSS can be widely used in electromagnetic protection, electromagnetic compatibility, antenna, filter and so on. Satellite communication mainly refers to the radio communication between the earth stations or between the earth station and the spacecraft through the communication satellite for signal forwarding. The working frequency bands for satellite communication mainly include centimeter-wave band, with a frequency range of 3-30 GH. This band corresponds to the IEEE S (2-4 GHz), C (4-8 GHz), Ku (12-18 GHz), K (18-27 GHz), and Ka (26.5-40 GHz) bands.

The operating frequency range of satellite communication is relatively wide, but the frequency selective surface of the existing frequency band used for satellite communication is a single frequency band, which has a single filter frequency band and poor structural stability, and cannot meet the requirements of more scenarios and higher performance. Moreover, the existing FSS structural unit is large, and may not meet the current demand for miniaturization structure.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a structural diagram of a frequency selective surface according to an embodiment of the present disclosure.

FIG. 2 is a structural diagram of a multi-band array unit according to a frequency selective surface according to an embodiment of the present disclosure.

FIG. 3 is a structural diagram of a reflection unit of the frequency selective surface in FIG. 2.

FIG. 4 is a structural diagram of a transmission unit of the frequency selective surface in FIG. 2.

FIG. 5 is a curve diagram of a center frequency in Ku band of the frequency selective surface changing with a width G.

FIG. 6 is a curve diagram of the center frequency in K-band of the frequency selective surface changing with a spacing A.

FIG. 7 is a curve diagram of the center frequency in Ka band of the frequency selective surface changing with a width D.

FIG. 8 is a schematic diagram of transmission simulation measurements of the frequency selective surface according to an embodiment of the present disclosure.

FIG. 9 is a schematic diagram of oblique emission simulation measurements of a frequency selective surface according to another embodiment of the present disclosure.

FIG. 10 is an ideal curve and a simulation curve of S-parameter of the frequency selective surface according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

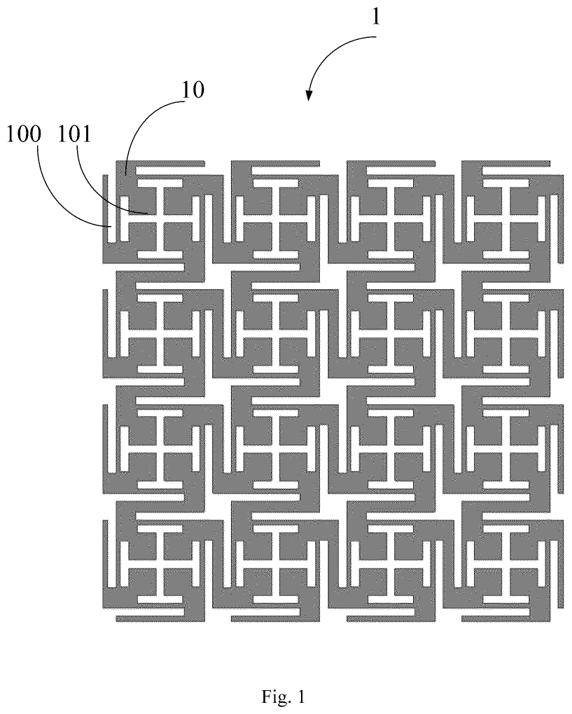

Referring to FIG. 1, FIG. 1 is a structural diagram of a frequency selective surface according to an embodiment of the present disclosure. In the embodiment, the frequency selective surface 1 is mainly applied to communication systems, such as low-orbit satellite communication systems and radar systems.

As shown in FIG. 1, the frequency selective surface 1 includes a plurality of multi-band array units 10 arranged in a periodic arrangement. Each of the plurality of multi-band array unit 10 has the same structure, and the periodic manner is preferably a matrix. As shown in FIG. 1, in the embodiment, the frequency selection surface 1 is represented by, but not limited to, a 4×4 matrix. In practical applications, the matrix size can be expanded according to communication requirements.

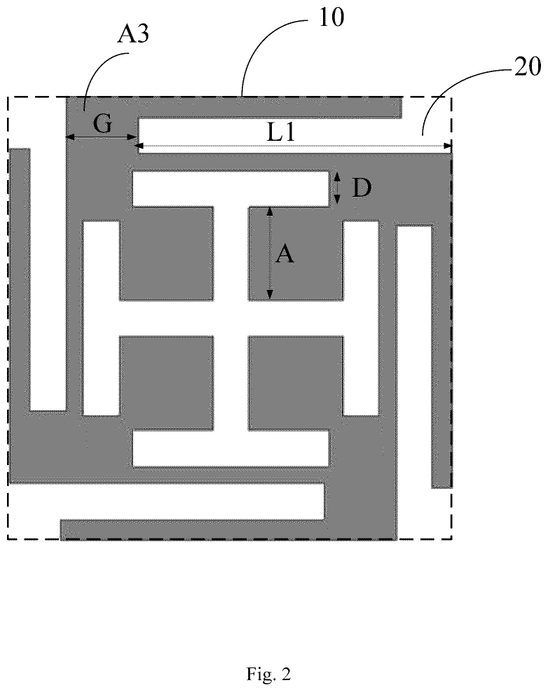

Combined with FIG. 2, FIG. 2 is a structural diagram of a multi-band array unit according to a frequency selective surface according to an embodiment of the present disclosure. As shown in FIG. 2, the multi-band array unit 10 includes a reflection unit 100 and a transmission unit 101. The reflection unit 100 is arranged on an upper surface 20 of a substrate, and the transmission unit 101 is also arranged on the upper surface 20 of the substrate. The reflection unit 100 and the transmission unit 101 are coincided to form a single layer multi-band array unit 10 that integrates reflection and transmission, which reduces the size of the multi-band array unit 10 to meet the miniaturization requirements.

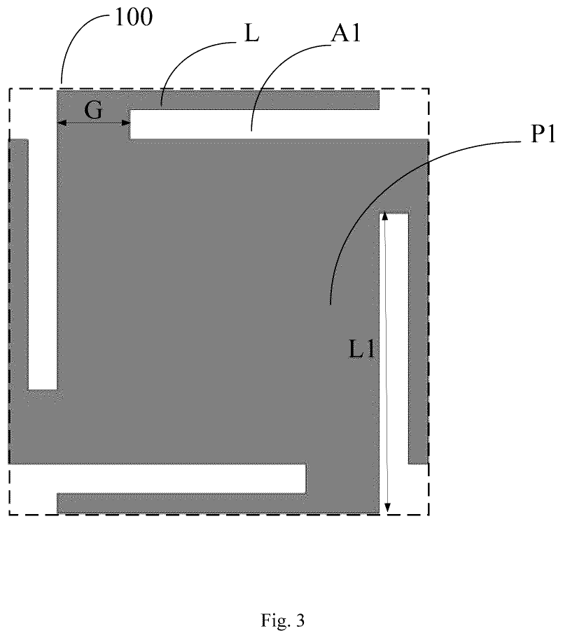

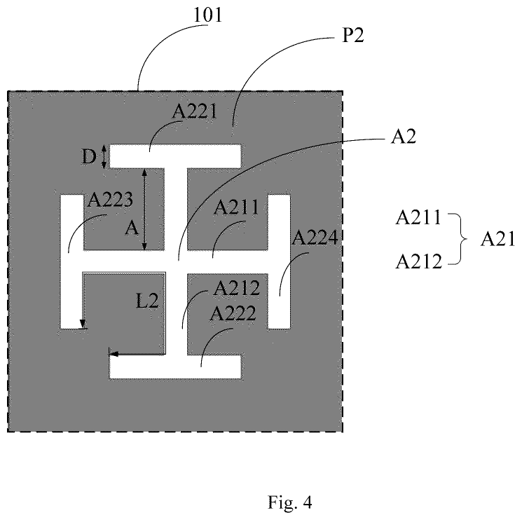

Specifically, combined with FIG. 3 and FIG. 4, FIG. 3 is a structural diagram of a reflection unit of the frequency selective surface in FIG. 2, and FIG. 4 is a structural diagram of a transmission unit of the frequency selective surface in FIG. 2. The reflection unit 100 includes a first metal rectangular patch P1, and four sides of the first metal rectangular patch P1 are respectively hollowed out an L-shaped slot A1, so that the four sides of the first metal rectangular patch P1 respectively retain a long branch L with one end suspended, forming a windmill shape. The transmission unit 101 includes a second metal rectangular patch P2, and a center of the second metal rectangular patch P2 is hollowed out a Jerusalem cross slot A2. Returning to FIG. 2, the first metal rectangular patch P1 of the reflection unit 100 and the second metal rectangular patch P2 of the transmission unit 101 have a same size, and overlap with each other. The Jerusalem cross slot A2 does not overlap with the L-shaped slot A1.

In the embodiment, the working frequency bands of reflection unit 100 are Ku band of 12 GHz-18 GHz and Ka band of 26.5 GHz-40 GHz, the working frequency band of transmission unit 101 is K band of 18 GHz-18 GHz, so the working frequency bands of multi-band array unit 10 composed of the reflection unit 100 and the transmission unit 101 are Ku band, Ka band and K band, which have a wide application range.

In the embodiment, a length of the multi-band array unit 10 is less than one-half wavelength of the center frequency of the Ku band, thus avoiding gate lobe generation.

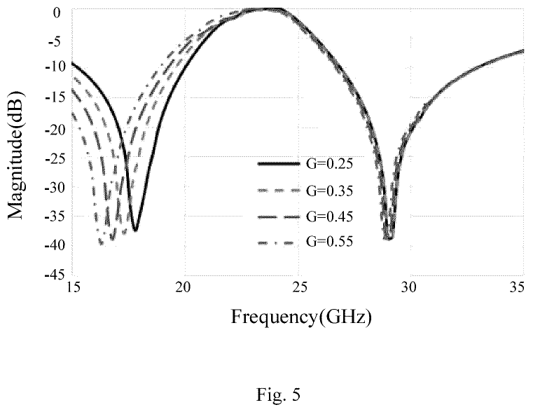

In the embodiment, a length L1 of the L-shaped unit A1 of the reflection unit 100 is a quarter wavelength of the center frequency of the Ku band. The center frequency of the working frequency of the reflection unit 100 in the Ku band is adjustable by adjusting the length of the L-shaped slot. Combined with FIG. 2, when the length L1 of L-shaped unit A1 changes, the width G of a metal block A3 also changes in accordance with the length L1, that is, the center frequency of the working frequency of the reflection unit 100 in the Ku band is adjustable by adjusting the width G of the metal block A3. Combined with FIG. 5, FIG. 5 is a curve diagram of a center frequency in Ku band of the frequency selective surface changing with the width G. As shown in FIG. 5, when the width G of the metal block A3 is 0.25 mm, the center frequency of the working frequency in the Ku band is about 17.8 GHz; when the width G of the metal block A3 is 0.35 mm, the center frequency of the working frequency in the Ku band is about 17.3 GHz; when the width G of the metal block A3 is 0.45 mm, the center frequency of the working frequency in the Ku band is about 16.8 GHz; and when the width G of the metal block A3 is 0.55 mm, the center frequency of the working frequency in the Ku band is about 16.3 GHz. Within a certain range, the center frequency of the working frequency in the Ku band shifts toward the lower frequency as the width G of the metal block A3 increases.

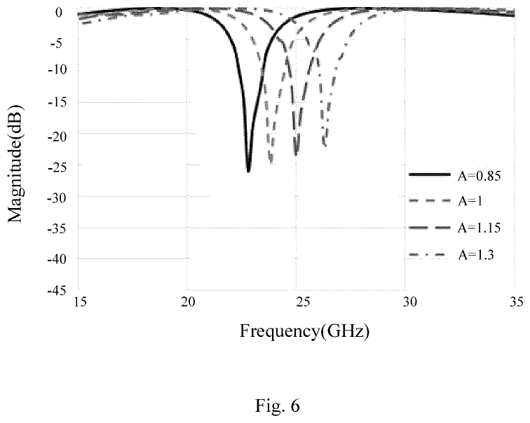

In the embodiment, a length L2 of a quarter of the Jerusalem Cross slot A2 is one-third wavelength of the center frequency of the K band. The center frequency of the working frequency band of the transmission unit 101 in the K band and the center frequency of the working frequency band of the reflection unit in the Ka band are adjustable by adjusting the size of the Jerusalem Cross slot A2. Specifically, the Jerusalem Cross slot A2 is a rotationally symmetric structure, and the Jerusalem Cross slot A2 includes a cross slot A21 and four rectangular slots A221-A224 arranged vertically at four ends of the cross slot A21. The cross slot A21 includes a first part A211 and a second part A212, and the first part A211 and the second part A212 are perpendicular to each other. The spacing between the first part A211 and the rectangular slot A221 and the spacing between the first part A211 and the rectangular slot A222 is A. The spacing between the second part A212 and the rectangular slot A223 and the spacing between the second part A212 and the rectangular slot A224 is also A. The width of the rectangular slots A221-A224 is D. The center frequency of the working frequency band of the transmission unit in the K band is adjustable by adjusting the length of the cross slot A21, that is, the center frequency of the working frequency band of the transmission unit in the K band is adjustable by adjusting the spacing A. Combined with FIG. 6, FIG. 6 is a curve diagram of the center frequency in K-band of the frequency selective surface changing with the spacing A. As shown in FIG. 6, when the spacing A is 0.85 mm, the center frequency of the working frequency in the K band is about 22.8 GHz; when the spacing A is 1 mm, the center frequency of the working frequency in the K band is about 23.9 GHz; when the spacing A is 1.15 mm, the center frequency of the working frequency in the K band is about 25.1 GHz; when the spacing A is 1.3 mm, the center frequency of the working frequency in the K band is about 26.2 GHz. Within a certain range, the center frequency of the working frequency in the K band shifts toward the high frequency as the spacing A increases.

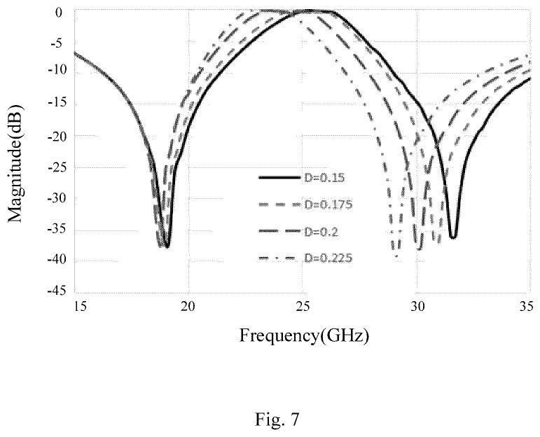

In the embodiment, the center frequency of the Ka band is adjustable by adjusting the width D of the rectangular slots A221-A224. Combined with FIG. 7, FIG. 7 is a curve diagram of the center frequency in Ka band of the frequency selective surface changing with the width D. When the width D is 0.15 mm, the center frequency of the working frequency in the Ka band is about 29.1 GHz; when the width D is 0.175 mm, the center frequency of the working frequency in the Ka band is about 23.9 GHz; when the width D is 0.2 mm, the center frequency of the working frequency in the Ka-band is about 30.1 GHz; when the width D is 0.225 mm, the center frequency of the working frequency in the Ka-band is about 31.7 GHz. Within a certain range, the center frequency of the working frequency in the K-band shifts towards higher frequency as the width D increases.

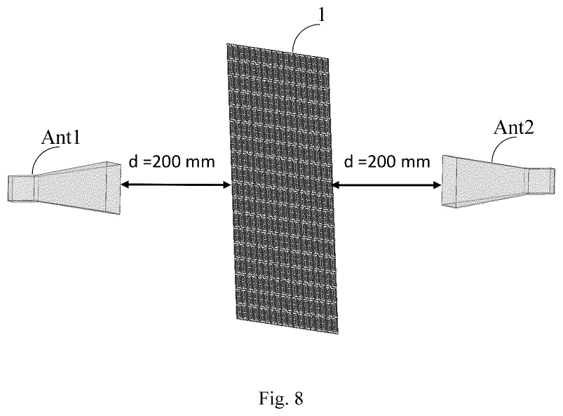

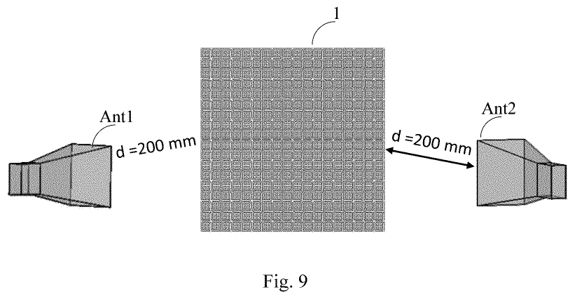

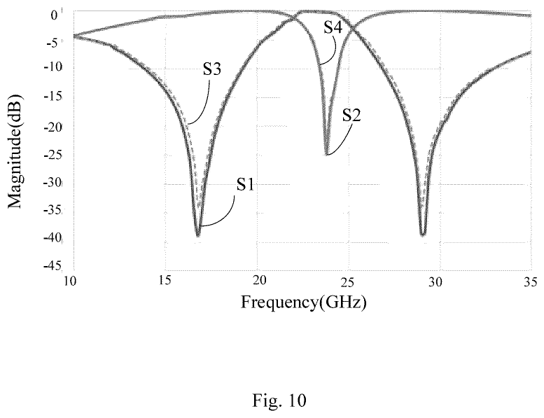

Referring to FIG. 8, FIG. 9 and FIG. 10, FIG. 8 is a schematic diagram of transmission simulation measurements of the frequency selective surface according to an embodiment of the present disclosure. As shown in FIG. 8, the frequency selective surface 1 is arranged in an 18×18 matrix, and an antenna Ant1 and an antenna Ant2 are respectively at a distance of d=200 mm from the frequency selective surface 1. The signals from the antenna Ant1 and the antenna Ant2 are transmitted vertically to the frequency selective surface 1. FIG. 9 is a schematic diagram of oblique emission simulation measurements of a frequency selective surface according to another embodiment of the present disclosure. The frequency selective surface 1 is arranged in an 18×18 matrix, and the antenna Ant1 and the antenna Ant2 respectively at a distance of d=200 mm from frequency selective surface 1. The signals from the antenna Ant1 and the antenna Ant2 are obliquely incident at a predetermined angle onto the frequency selective surface 1. FIG. 10 is an ideal curve and a simulation curve of S-parameter of the frequency selective surface according to an embodiment of the present disclosure. As shown in FIG. 10, curve S1 is an ideal curve of S-parameter in the oblique emission scene; curve S2 is an ideal curve of S-parameter in the transmission scene; curve S3 is a simulation curve diagram of S-parameter in the oblique emission scene; curve S4 is a simulation curve diagram of S-parameter in the transmission scene. The trends of the curve S3 and the curve S4 are consistent with those of the curve S1 and the curve S2 respectively, indicating stable performance of the frequency selective surface 1. The center frequency of the working frequency in the Ku band is about 16.3 GHz, the center frequency of the working frequency in the K band is about 22.8 GHz, and the center frequency of the working frequency in the Ka band is about 29.1 GHz. The frequency selective surface 1 has three operating frequency bands and a wide range of applications.

Compared with the prior art, the frequency selective surface provided by the embodiment of the present disclosure includes a plurality of multi-band array units arranged periodically, and each multi-band array unit includes a reflection unit and a transmission unit, which are arranged on the upper surface of the substrate, and the reflection unit and transmission unit overlap each other, thus reducing the size of the frequency selection surface and meeting the miniaturization requirements.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A frequency selective surface comprising a plurality of multi-band array units arranged in a periodic manner, each of the plurality of multi-band array units comprising:
a reflection unit arranged on an upper surface of a substrate, wherein the reflection unit comprises a first metal rectangular patch, and four sides of the first metal rectangular patch are respectively hollowed out an L-shaped slot such that the four sides of the first metal rectangular patch respectively retain a long rectangular branch with one end suspended, forming a windmill shape; and
a transmission unit arranged on the upper surface of the substrate, wherein the transmission unit comprises a second metal rectangular patch, a center of the second metal rectangular patch is hollowed out a Jerusalem cross slot, the second metal rectangular patch of the transmission unit and the first metal rectangular patch of the reflection unit having a same size, and overlapping with each other.

2. The frequency selective surface according to claim 1, wherein the periodic manner is a matrix.

3. The frequency selective surface according to claim 1, wherein:
working frequency bands of the reflection unit are Ku band of 12 GHz-18 GHz and Ka band of 26.5 GHz-40 GHz;
a working frequency band of the transmission unit is K band of 18 GHz-18 GHz.

4. The frequency selective surface according to claim 3, wherein a length of each of the multi-band array unit is less than one-half wavelength of a center frequency of the Ku band.

5. The frequency selective surface according to claim 3, wherein a length of the L-shaped slot of the reflection unit is one-quarter wavelength of a center frequency of the Ku band.

6. The frequency selective surface according to claim 3, wherein a length of a quarter of the Jerusalem cross slot is one-third wavelength of a center frequency of the K band.

7. The frequency selective surface according to claim 3, wherein a center frequency of the working frequency band of the reflection unit in the Ku band is adjustable by adjusting to a length of the L-shaped slot.

8. The frequency selective surface according to claim 3, wherein the Jerusalem cross slot is a rotationally symmetric structure, and the Jerusalem cross slot comprises a cross slot and four rectangular slots vertically arranged at four ends of the cross slot.

9. The frequency selective surface according to claim 8, wherein:
a center frequency of the working frequency band of the transmission unit in the K band is adjustable by adjusting a length of the Jerusalem cross slot;
a center frequency of the working frequency band of the reflection unit in the Ka band is adjustable by adjusting a width of the four rectangular slots.

10. A communication system comprising a frequency selective surface, wherein the frequency selective surface comprises a plurality of multi-band array units arranged in a periodic manner, and each of the plurality of multi-band array unit comprises:
a reflection unit arranged on an upper surface of a substrate, wherein the reflection unit comprises a first metal rectangular patch, and four sides of the first metal rectangular patch are respectively hollowed out an L-shaped slot such that the four sides of the first metal rectangular patch respectively retain a long rectangular branch with one end suspended, forming a windmill shape; and
a transmission unit arranged on the upper surface of the substrate, wherein the transmission unit comprises a second metal rectangular patch, a center of the second metal rectangular patch is hollowed out a Jerusalem cross slot, the second metal rectangular patch of the transmission unit and the first metal rectangular patch of the reflection unit having a same size, and overlapping with each other.

11. The communication system according to claim 10, wherein the periodic manner is a matrix.

12. The communication system according to claim 10, wherein:
a working frequency band of the reflection unit is Ku band of 12 GHz-18 GHz and Ka band of 26.5 GHz-40 GHz;
a working frequency band of the transmission unit is K band of 18 GHz-18 GHz.

13. The communication system according to claim 12, wherein a length of each of multi-band array unit is less than one-half wavelength of a center frequency of the Ku band.

14. The communication system according to claim 12, wherein a length of the L-shaped slot of the reflection unit is one-quarter wavelength of a center frequency of the Ku band.

15. The communication system according to claim 12, wherein a length of a quarter of the Jerusalem cross slot is one-third wavelength of a center frequency of the K band.

16. The communication system according to claim 12, wherein a center frequency of the working frequency band of the reflection unit in the Ku band is adjustable by adjusting to a length of the L-shaped slot.

17. The communication system according to claim 12, wherein the Jerusalem cross slot is a rotationally symmetric structure, and the Jerusalem cross slot comprises a cross slot and four rectangular slots vertically arranged at four ends of the cross slot.

18. The communication system according to claim 17, wherein:
a center frequency of the working frequency band of the transmission unit in the K band is adjustable by adjusting a length of the Jerusalem cross slot;
a center frequency of the working frequency band of the reflection unit in the Ka band is adjustable by adjusting a width of the four rectangular slots.
